(19) United States
(12) Patent Application Publication
(10) Pub. No.: US 2014/0346148 A1
(43) Pub. Date: Nov. 27, 2014

(54) WELDING OPERATION MANAGEMENT DEVICE, WELDING OPERATION MANAGEMENT SYSTEM, WELDING OPERATION MANAGEMENT METHOD, AND WELDING OPERATION TERMINAL

(71) Applicants: Yuji KATOH, Kanagawa (JP); Tsutsumi Nakamura, Kanagawa (JP); Kohi Ogata, Kanagawa (JP); Masaaki Furihata, Kanagawa (JP); Toshiharu Takai, Kanagawa (JP)

(72) Inventors: Yuji KATOH, Kanagawa (JP); Tsutsumi Nakamura, Kanagawa (JP); Kohi Ogata, Kanagawa (JP); Masaaki Furihata, Kanagawa (JP); Toshiharu Takai, Kanagawa (JP)

(21) Appl. No.: 14/456,619

(22) Filed: Aug. 11, 2014

Related U.S. Application Data
(62) Division of application No. 13/256,959, filed on Sep. 28, 2011.

(30) Foreign Application Priority Data
Mar. 19, 2009 (JP) 2009-068275

(51) Int. Cl. B23K 9/095; B23K 31/00

(52) U.S. Cl. CPC B23K 9/0953; B23K 31/00
USPC 219/59.1

(57) ABSTRACT

Disclosed is a welding operation management device characterized by being provided with a weld joint specification table (101a) that associates material qualities of pipe materials and welding execution methods as pipe weld joint specifications in plant construction work with weld joints, a welding execution method table (101c) that associates base metal classes into which the material qualities are classified, weld material classes into which weld materials used for welding are classified, and welding method classes into which welding execution methods are classified with welding execution methods, a weld material identification table (101f) that associates the base material classes and the weld material classes with the weld materials, and a weld material identification unit (105); that acquires the welding execution method and material quality of a desired weld joint from the weld joint specification table (101a), acquires the weld material class thereof from the welding execution method table (101c), and identifies the weld material of the weld joint from the weld material identification table (101f) on the basis of the base metal class of the material quality and the weld material class.

### CROSS-REFERENCE TO RELATED APPLICATIONS

This application is a division of U.S. application Ser. No. 13/256,959 filed Sep. 28, 2011, the entire contents of which is incorporated herein by reference. U.S. application Ser. No. 13/256,959 is a National Stage of PCT/JP10/001991 filed Mar. 19, 2010, which is based upon and claims the benefit of priority to Japanese Patent Application No. 2009-068275 filed Mar. 19, 2009.

### TECHNICAL FIELD

The present invention relates to a welding operation management device that supports a pipe welding operation and a welding management operation in plant construction work, a welding operation management system, a welding operation management method, and a welding operation terminal.

### BACKGROUND ART

In piping work of plant construction work, welding inspection based on laws or the like or welding management conforming thereto is frequently required (see, for example, Japanese Patent Application Laid-Open Nos. 2007-193557 and 2008-59116). That is, welding shall be designed according to standards, a certified welder shall do welding according to a permitted method, and required welding inspection shall be passed.

In the welding design, information such as the material quality of pipe, pipe diameter, pipe thickness, and joint design from execution drawings, a welding execution method meeting the conditions is found for each weld joint, and whether the method fulfils design instruction conditions is checked.

### CITATION LIST

### Patent Literature

PLT 1: Japanese Patent Application Laid-Open No. 2007-193557

PLT 2: Japanese Patent Application Laid-Open No. 2008-59116

### SUMMARY OF THE INVENTION

### Technical Problem

However, the number of weld joints of pipe in plant construction work extends to several tens of thousand and deciding the welding execution method for each weld joint requires enormous efforts and also leads to man-made errors.

Moreover, to guarantee quality of welding, it is absolutely necessary not only to decide the welding execution method, but also to select weld materials to be used and the welder possessing required welding qualifications. However, the number of combinations of the weld material and welding qualifications for one welding execution method is not necessarily one, which makes the identification difficult.

In view of the above problems of the conventional technology, an object of the present invention is to provide a welding operation management device, a welding operation management system, a welding operation management method, and a welding operation terminal that improve reliability and efficiency of a pipe welding operation and a welding management operation in plant construction work.

### Solution to Problem

According to an aspect of the present invention, a welding operation management device including a weld joint specification input unit that inputs at least an identifier of a weld joint, a welding execution method, a joint design, a material quality of the pipe, a pipe diameter, and a pipe thickness as weld joint specifications between pipes mutually welded in plant construction work, a welding portion thickness identification table that stores the joint design, the pipe diameter, and the pipe thickness by associating with a thickness of a welding portion, a welding execution method table that stores base metal classes classifying the material quality of the pipe, weld material classes classifying weld materials used for welding, and welding method classes classifying welding execution methods by associating with the welding execution methods, and a weld joint specification inspection unit that refers to the welding portion thickness identification table using the joint design, the pipe diameter, and the pipe thickness having been input as keys to inspect consistency of the joint design, the pipe diameter, and the pipe thickness and also refers to the welding execution method table using the base metal class concerning the material quality as the key to inspect the consistency of a combination of the material qualities of the pipes and the welding execution methods is provided.

According to another aspect of the present invention, a welding operation management device including a weld joint specification table that stores a material quality of an pipe and a welding execution method by associating with a weld joint as weld joint specifications between the pipes mutually welded in plant construction work, a welding execution method table that stores base metal classes classifying the material quality, weld material classes classifying weld materials used for welding, and welding method classes classifying the welding execution methods by associating with the welding execution methods, a weld material identification table that stores the base metal classes and the weld material classes by associating with the weld materials and a weld material identification unit that acquires the welding execution method and the material quality concerning the desired weld joint from the weld joint specification table and acquires the weld material class from the welding execution method table to identify the weld material concerning the weld joint from the weld material identification table based on the base metal class concerning the acquired material quality and the weld material class is provided.

According to still another aspect of the present invention, a welding operation management system, including a welding operation management device that creates welding operation instruction information based on weld joint specifications between pipes mutually welded in plant construction work and a welding operation terminal that acquires the welding operation instruction information from the welding operation management device, wherein the welding operation management device, including a weld joint specification table that stores at least a material quality of the pipe, a joint design, a pipe diameter, a pipe thickness, and a welding execution method by associating with a weld joint as the weld joint specifications, a welding execution method table that stores base metal classes classifying the material quality, weld material classes classifying weld materials used for welding, and welding method classes classifying the welding execution methods by associating with the welding execution methods, a weld material identification table that stores the base metal classes and the weld material classes by associating with the weld materials, and a weld material identification unit that acquires the welding execution method and the material quality concerning the desired weld joint from the weld joint specification table and also acquires the weld material class from the welding execution method table to identify the weld material concerning the weld joint from the weld material identification table based on the base metal class concerning the acquired material quality and the weld material class is provided.

According to still another aspect of the present invention, A welding operation management method, including a weld joint specification acquisition step of acquiring weld joint specifications from a weld joint specification table that stores a material quality of a pipe and a welding execution method by associating with a weld joint as the weld joint specifications between the pipes mutually welded in plant construction work using an identifier of the weld joint as a key, a weld material class acquisition step of acquiring a weld material class from a welding execution method table that stores base metal classes classifying the material quality, the weld material classes classifying weld materials used for welding, and welding method classes classifying the welding execution methods by associating with the welding execution methods based on the welding execution method contained in the weld joint specifications acquired in the weld joint specification acquisition step, and a weld material identification step of identifying the weld material concerning the weld joint from a weld material identification table that stores the base metal classes and the weld material classes by associating with identification information of the weld materials based on the base metal class concerning the material quality contained in the weld joint specifications and the weld material class acquired in the weld material class acquisition step is provided.

According to still another aspect of the present invention, a welding operation management method, including inputting at least an identifier of a weld joint, a welding execution method, a joint design, a material quality of a pipe, a pipe diameter, and a pipe thickness into a weld joint specification input unit as weld joint specifications between the pipes mutually welded in plant construction work, storing the joint design, the pipe diameter, and the pipe thickness in a welding portion thickness identification table by associating with a thickness of a welding portion, storing base metal classes classifying the material quality of the pipes, weld material classes classifying weld materials used for welding, and welding method classes classifying the welding execution methods in a welding execution method table by associating with the welding execution methods, and inspecting consistency of the joint design, the pipe diameter, and the pipe thickness by referring to the welding portion thickness identification table using the joint design, the pipe diameter, and the pipe thickness having been input as keys and also inspecting the consistency of a combination of the material qualities of the pipes and the welding execution methods by referring to the welding execution method table using the base metal class concerning the material quality as the key is provided.

According to still another aspect of the present invention, a welding operation terminal connected to a welding operation management device storing welding operation instruction information containing welding qualifications required for welding operations of pipes in plant construction work and possessed welding qualification information of welders, including a welding operation instruction acquisition unit that acquires the welding operation instruction information for each weld joint from the welding operation management device, a possessed welding qualification acquisition unit that acquires the possessed welding qualification information from the welding operation management device using identification information of the welder as a key, a welding qualification determination unit that determines whether the acquired possessed welding qualification information matches the welding qualifications contained in the welding operation instruction information acquired by the welding operation instruction acquisition unit for each of the weld joints, and a warning information output unit that outputs warning information based on determination results is provided.

### Advantageous Effects of Invention

According to the present invention, a welding operation management device, a welding operation management system, a welding operation management method, and a welding operation terminal that improve reliability and efficiency of a pipe welding operation and a welding management operation in plant construction work will be provided.

### BRIEF DESCRIPTION OF THE DRAWINGS

FIG. 1 is a block diagram showing an overall configuration example of a welding operation management system according to an embodiment of the present invention.

FIG. 2 is a diagram showing a concrete example of a weld joint specification table shown in FIG. 1.

FIG. 3 is a diagram showing a concrete example of a thickness identification table of a welding portion shown in FIG. 1.

FIG. 4 is a diagram showing a concrete example of a welding execution method table shown in FIG. 1.

FIG. 5 is a diagram showing a concrete example of a material quality/base metal class conversion table shown in FIG. 1.

FIG. 6 is a diagram showing a concrete example of a welding execution method/joint design correspondence table shown in FIG. 1.

FIG. 7 is a diagram showing a concrete example of a weld material identification table shown in FIG. 1.

FIG. 8 is a diagram showing a concrete example of a welding qualification identification table shown in FIG. 1.

FIG. 9 is a diagram showing a concrete example of a possessed welding qualification table shown in FIG. 1.

FIG. 10 is a diagram showing a concrete example of a weld material delivery information table shown in FIG. 1.

FIG. 11 is a diagram showing a concrete example of a welding execution information table shown in FIG. 1.

FIG. 12 is a diagram showing a concrete example of welding operation instructions.

FIG. 13 is a diagram showing a concrete example of welding execution records.

FIG. 14 is a block diagram showing a configuration example of a welding operation terminal shown in FIG. 1.

FIG. 15 is a correlation diagram illustrating an operation of a welding operation management system according to an embodiment of the present invention.

FIG. 16 is a flow chart showing a concrete example of processing of a weld joint specification inspection unit shown in FIG. 1.

FIG. 17 is a flow chart showing a concrete example of processing of a weld material identification unit shown in FIG. 1.

FIG. 18 is a flow chart showing a concrete example of processing of a welding qualification identification unit shown in FIG. 1.

FIG. 19 is a diagram showing a concrete example of the weld joint.

FIG. 20 is an enlarged view of the weld joint shown in FIG. 19.

FIG. 21 is a sectional view in a cross section A-A′ of a consumable insert shown in FIG. 20.

FIG. 22 is a correlation diagram of each program and a device for inspection and registration of weld joint specifications and identification of weld materials.

FIG. 23 is a correlation diagram of each program and the device for identification of weld joint specifications and welding operation instructions.

FIG. 24 is a correlation diagram of each program and the device for creation of a weld joint identification label.

FIG. 25 is a correlation diagram of each program and the device for registration of welding execution information.

FIG. 26 is a correlation diagram of each program of the welding operation terminal shown in FIG. 14.

### DESCRIPTION OF EMBODIMENTS

### Explanation of Terms

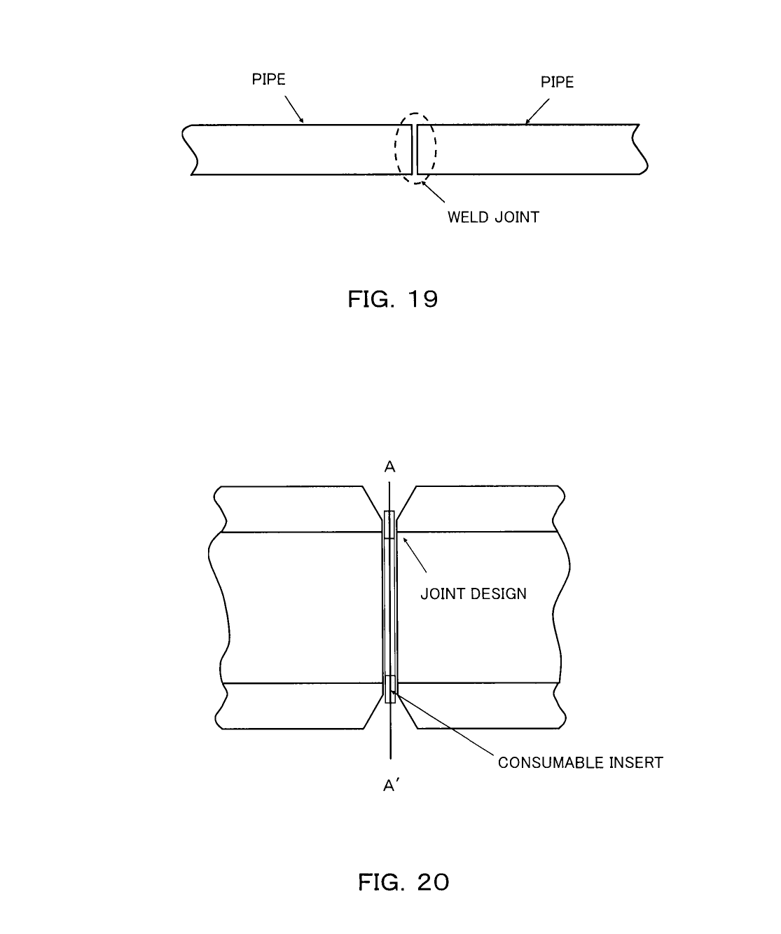

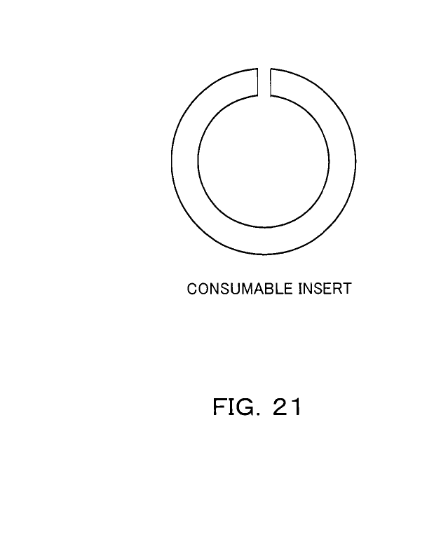

First, terms of welding operation used in an embodiment of the present invention will be described.
“Welding” is an operation to integrate two or more members by applying heat, pressure, or both so that the members to be joined have continuity therebetween. There are many welding methods and can roughly be divided into three categories: (1) fusion welding like shielded metal arc welding in which base metal is fused by heating for welding, (2) pressure welding like resistance welding in which pressure is applied for welding, and (3) brazing in which the base metal itself is not fused and instead, an alloy whose melting point is lower than that of the base metal is used as a filler metal for welding.
“Weld joint” is a joint to be welded. FIG. 19 is a diagram showing a concrete example of the weld joint.
“Base metal” is a metal (material) on the side to be welded.
“Joint design” is the shape of a groove provided between joints to be welded and there are many types such as an I-type groove, V-type groove, and Y-type groove. The shape and dimensions of a groove is closely related to welding results. FIG. 20 is an enlarged view of the weld joint shown in FIG. 19.
“Pipe diameter” is a nominal outside diameter (such as 100A and 50A) of a pipe.
“Pipe thickness” is a nominal thickness (such as S40 and S80) of a pipe. “S” is an abbreviation for schedule.
“Covered electrode” is a weld material (shielded metal arc welding covered electrode) used for shielded metal arc welding.
“Filler metal” is a metal (weld material used for TIG welding) added during welding.
“Consumable insert” is a metal material belonging to the same group as the base metal placed in a route portion in advance for butt welding and is often called an insert ring. FIG. 21 is a sectional view in a cross section A-A′ of a consumable insert shown in FIG. 20.

### Embodiment

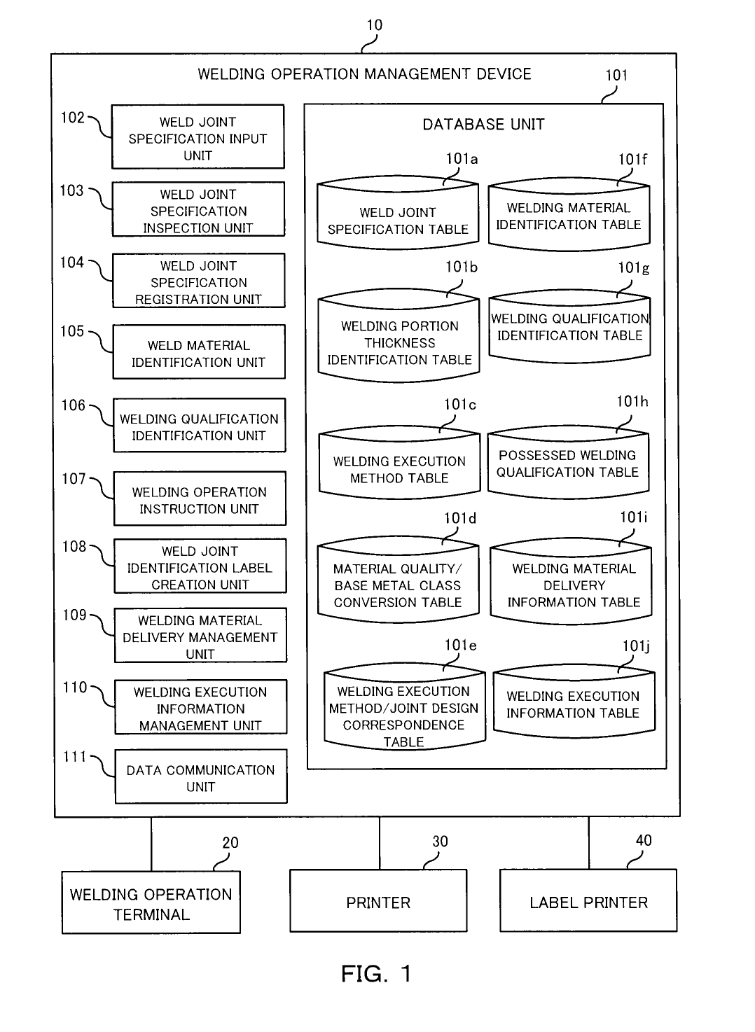

An embodiment of the present invention will be described below using drawings. FIG. 1 is a block diagram showing an overall configuration example of a welding operation management system according to an embodiment of the present invention. As shown in FIG. 1, a welding operation management system according to the present embodiment includes a welding operation management device 10, a welding operation terminal 20, a printer 30, and a label printer 40.

The welding operation management device 10 is a computer that creates various kinds of information (hereinafter, referred to as “welding operation instruction information”) issuing instructions to the welder concerning the welding method, execution location and the like based on specifications of the weld joint (welding portion) (hereinafter, referred to as “weld joint specifications”) of pipe in plant construction work.

The welding operation terminal 20 is a computer that acquires welding operation instruction information from the welding operation management device 10 and the welder performs a welding operation based on the welding operation instruction information displayed in the terminal.

As shown in FIG. 1, the welding operation management device 10 includes a database unit 101, a weld joint specification input unit 102, a weld joint specification inspection unit 103, a weld joint specification registration unit 104, a weld material identification unit 105, a welding qualification identification unit 106, a welding operation instruction unit 107, a weld joint identification label creation unit 108, a weld material delivery management unit 109, a welding execution information management unit 110, and a data communication unit 111.

The database unit 101 is a database including a weld joint specification table 101a, a welding portion thickness identification table 101b, a welding execution method table 101c, a material quality/base metal class conversion table 101d, a welding execution method/joint design correspondence table 101e, a weld material identification table 101f, a welding qualification identification table 101g, a possessed welding qualification table 101h, a weld material delivery information table 101i, and a welding execution information table 101j.

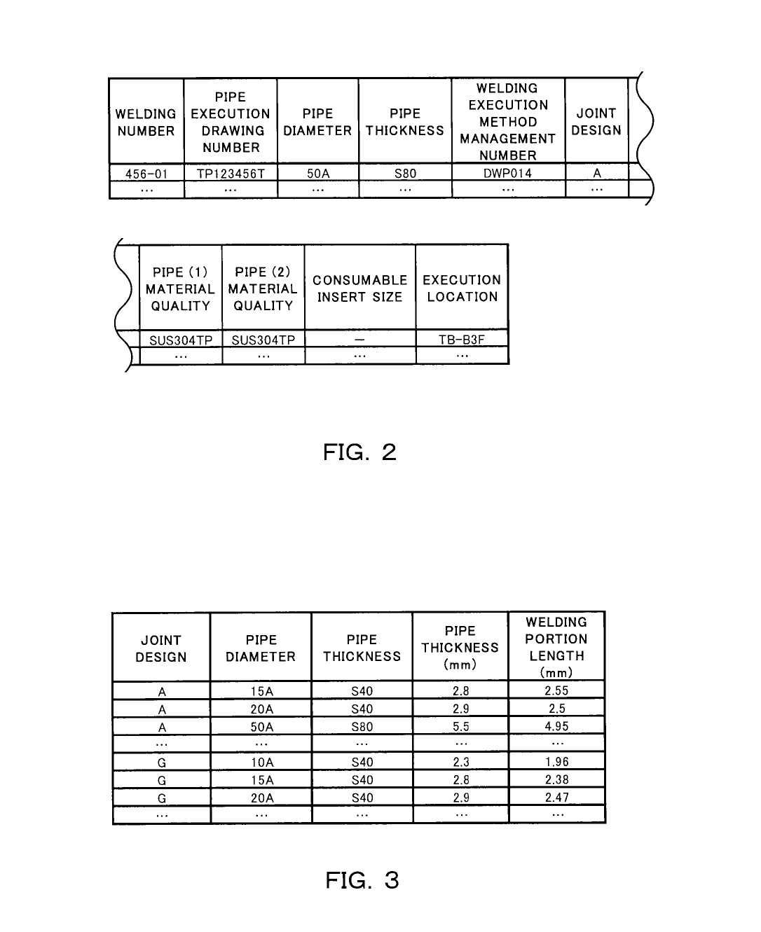

The weld joint specification table 101a is a table that stores at least the material quality of pipe, joint design, pipe diameter, pipe thickness, welding execution method management number, and execution location by associating with the weld joint number as weld joint specifications between pipes mutually welded in plant construction work. FIG. 2 is a diagram showing a concrete example of the weld joint specification table 101a.

The welding portion thickness identification table 101b is a table that stores the pipe joint design, pipe diameter (pipe caliber), and pipe thickness by associating with the thickness of a welding portion. FIG. 3 is a diagram showing a concrete example of the welding portion thickness identification table 101b.

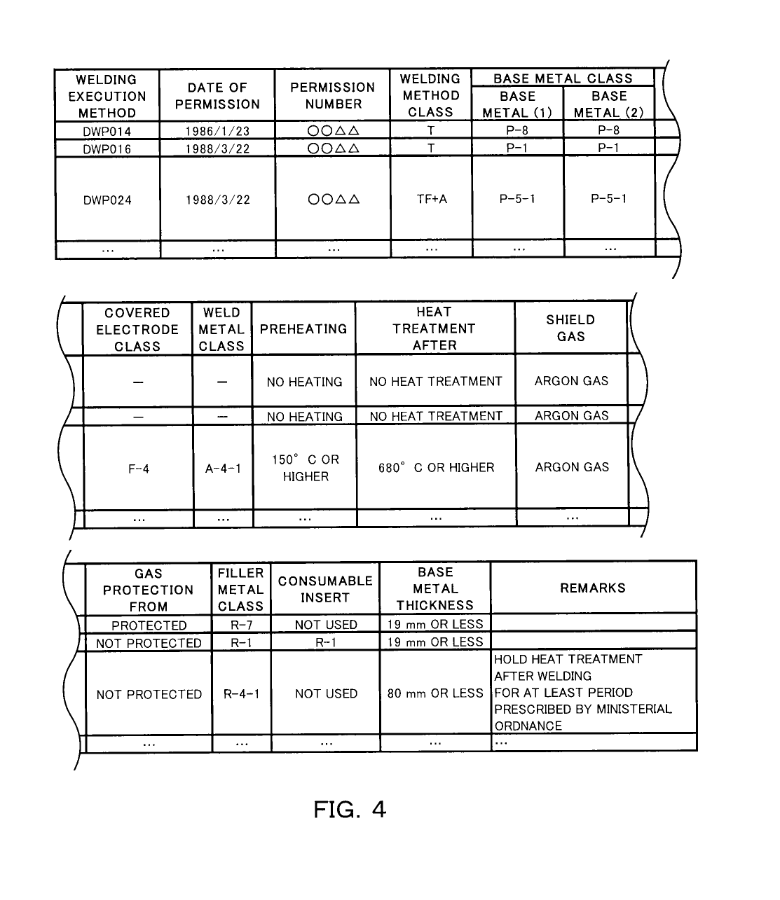

The welding execution method table 101c is a table that stores base metal classes classifying material qualities of pipe, weld material classes classifying weld materials (covered electrode/filler metal) used for welding, and welding method classes classifying welding execution method management numbers by associating with the welding execution method management number. FIG. 4 is a diagram showing a concrete example of the welding execution method table 101c.

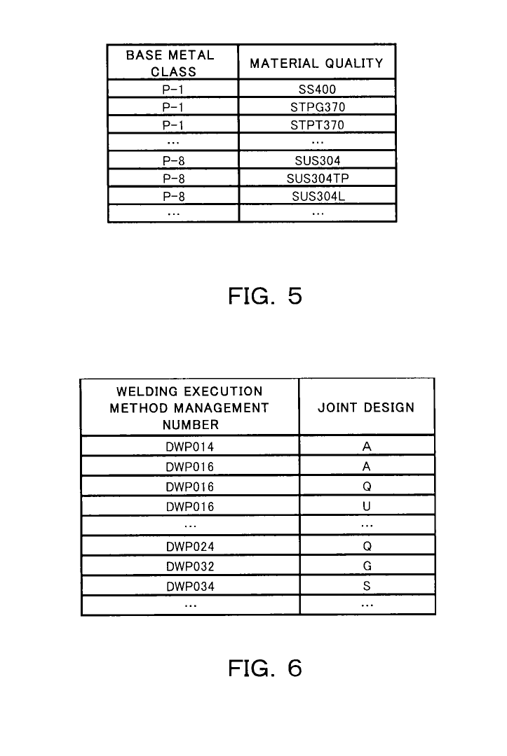

The material quality/base metal class conversion table 101d is a table that stores by associating material qualities of pipe and base metal classes. FIG. 5 is a diagram showing a concrete example of the material quality/base metal class conversion table 101d.

The welding execution method/joint design correspondence table 101e is a table that stores by associating the welding execution method management number and the joint design. FIG. 6 is a diagram showing a concrete example of the welding execution method/joint design correspondence table 101e.

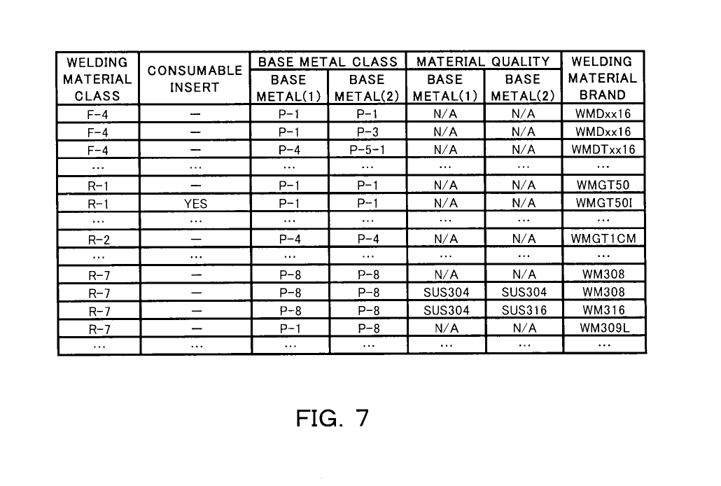

The weld material identification table 101f is a table that stores base metal classes of pipe, material quality of pipe, and weld material classes by associating with weld materials (weld material brands). FIG. 7 is a diagram showing a concrete example of the weld material identification table 101f.

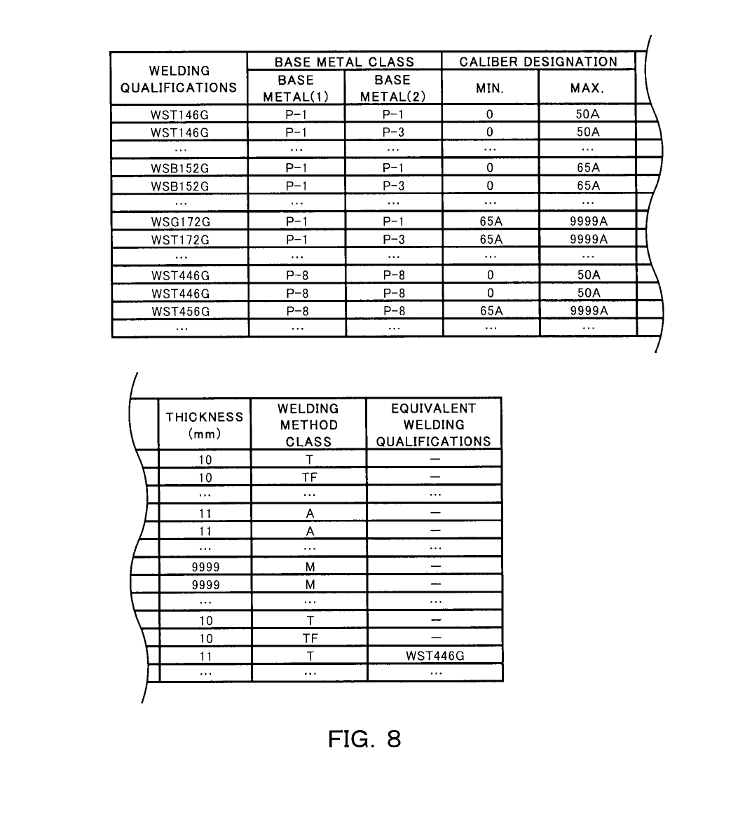

The welding qualification identification table 101g is a table that stores welding method classes, base metal classes, and pipe diameters by associating with welding qualifications required for welding operations. FIG. 8 is a diagram showing a concrete example of the welding qualification identification table 101g.

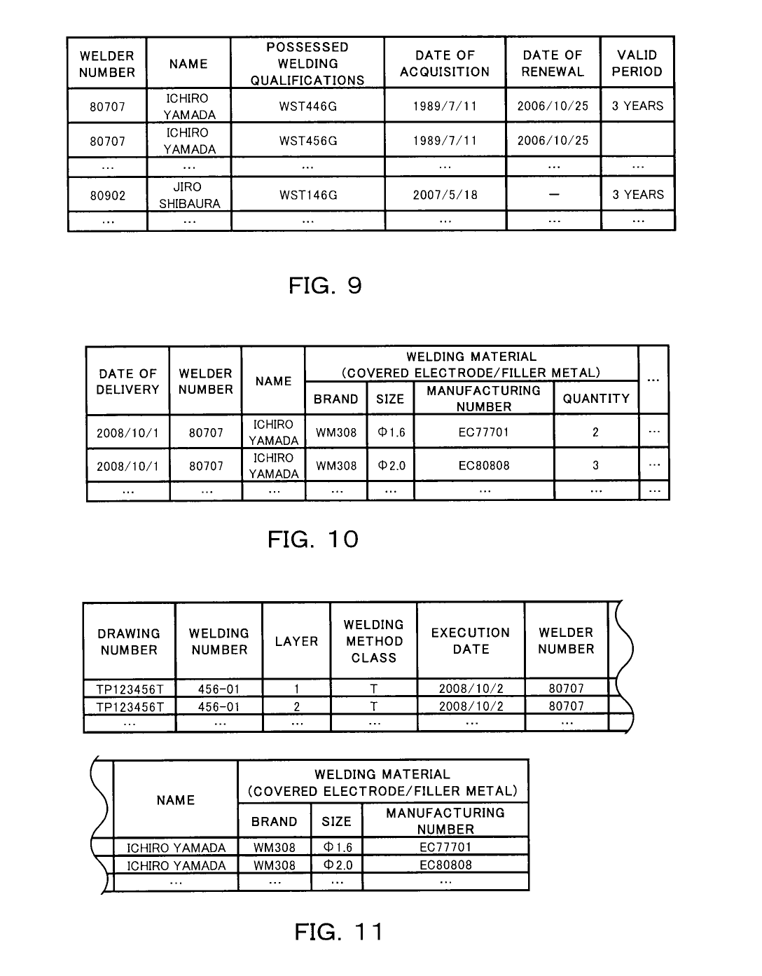

The possessed welding qualification table 101h is a table that stores by associating welder identification information and possessed welding qualifications. FIG. 9 is a diagram showing a concrete example of the possessed welding qualification table 101h.

The weld material delivery information table 101i is a table that stores brands, manufacturing numbers, and quantities of weld materials delivered by the welder for welding operations as weld material delivery information. FIG. 10 is a diagram showing a concrete example of the weld material delivery information table 101i.

The welding execution information table 101j is a table that stores welding operation information acquired from the welding operation terminal 20 used by the welder for welding operations. FIG. 11 is a diagram showing a concrete example of the welding execution information table 101j.

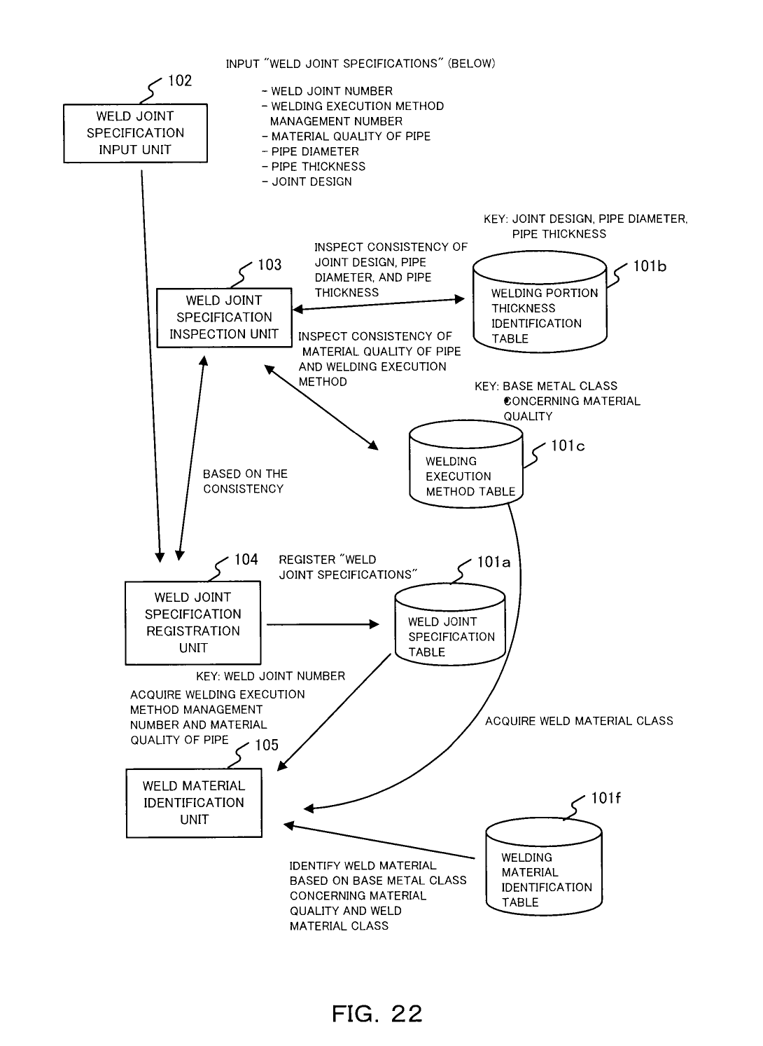

FIG. 22 is a correlation diagram of each program and a device for inspection and registration of weld joint specifications and identification of weld materials.

As shown in FIG. 22, the weld joint specification input unit 102 is a program that inputs welding joint specifications such as the welding joint number, welding execution method management number, joint design, material quality of pipe, pipe diameter, and pipe thickness via a registration screen displayed by a GUI (Graphical User Interface).

As shown in FIG. 22, the weld joint specification inspection unit 103 is a program that inspects consistency of the joint design, pipe diameter, and pipe thickness by referring to the welding portion thickness identification table 101b using the joint design, pipe diameter, and pipe thickness input through the weld joint specification input unit 102 as keys and also inspects consistency of a combination of material qualities of pipes and welding execution methods by referring to the welding execution method table 101c using base metal classes concerning material quality as a key.

As shown in FIG. 22, the weld joint specification registration unit 104 is a program that registers welding joint specifications input through the weld joint specification input unit 102 based on inspection results by the weld joint specification inspection unit 103 with the weld joint specification table 101a. In the weld joint specification table 101a, weld joint specifications are stored in registration units of the identification number (welding number) assigned to each weld joint (welding portion).

As shown in FIG. 22, the weld material identification unit 105 is a program that acquires the welding execution method management number and material quality of pipe concerning a desired weld joint from the weld joint specification table 101a and also acquires the weld material class from the welding execution method table 101c to identify the weld materials concerning the weld joint from the weld material identification table 101f based on the base metal class of the acquired material quality and the weld material class.

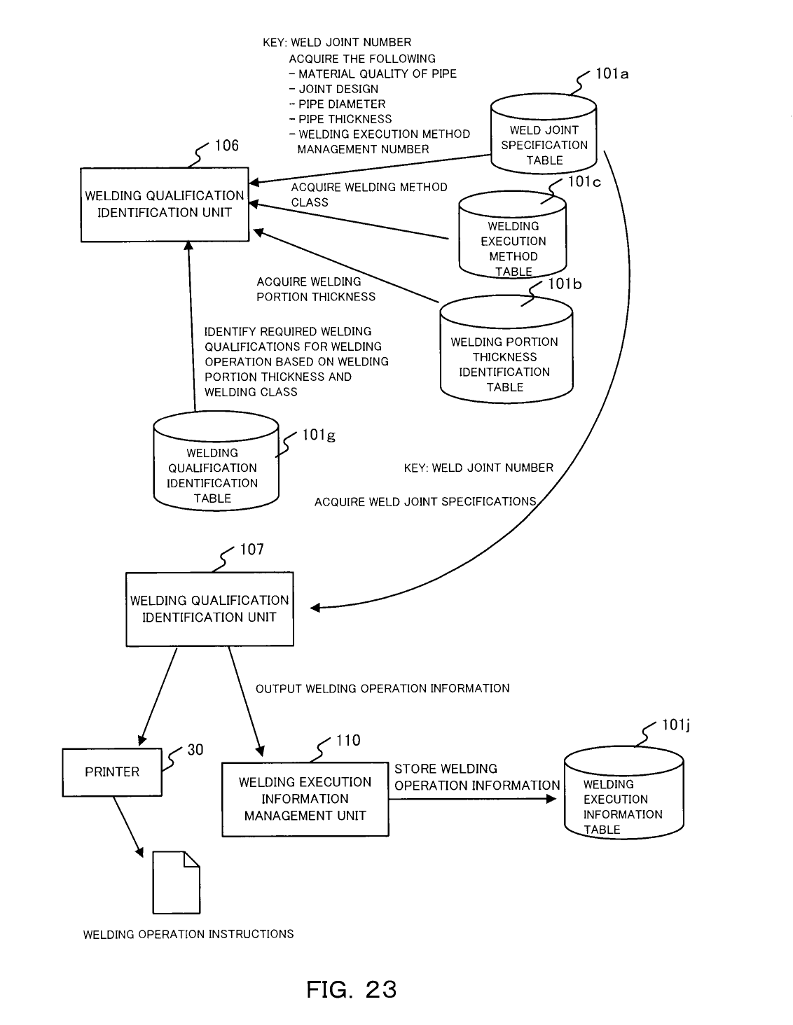

FIG. 23 is a correlation diagram of each program and the device for identification of weld joint specifications and welding operation instructions. As shown in FIG. 23, the welding qualification identification unit 106 is a program that acquires the material quality of pipe, joint design, pipe diameter, pipe thickness, and welding operation method management number concerning a desired weld joint from the weld joint specification table 101a and also acquires the welding method class from the welding execution method table 101c and the welding portion thickness from the welding portion thickness identification table 101b to identify welding qualifications required for the welding operation (hereinafter, referred to as “required welding qualifications”) for each weld joint from the welding qualification identification table 101g based on the base metal class concerning the material quality of pipe, welding portion thickness, and welding method class.

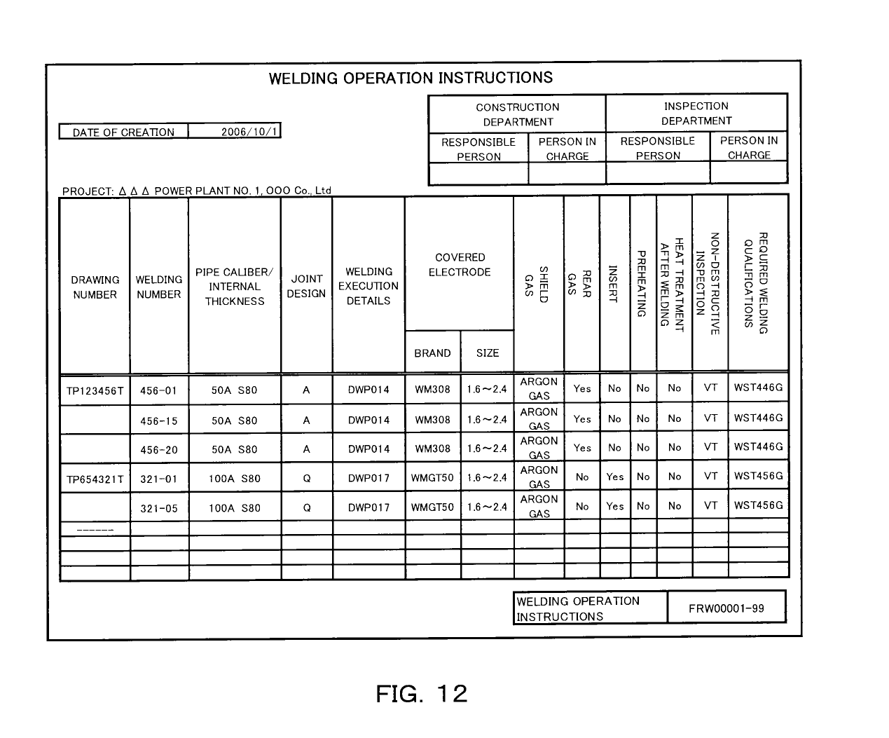

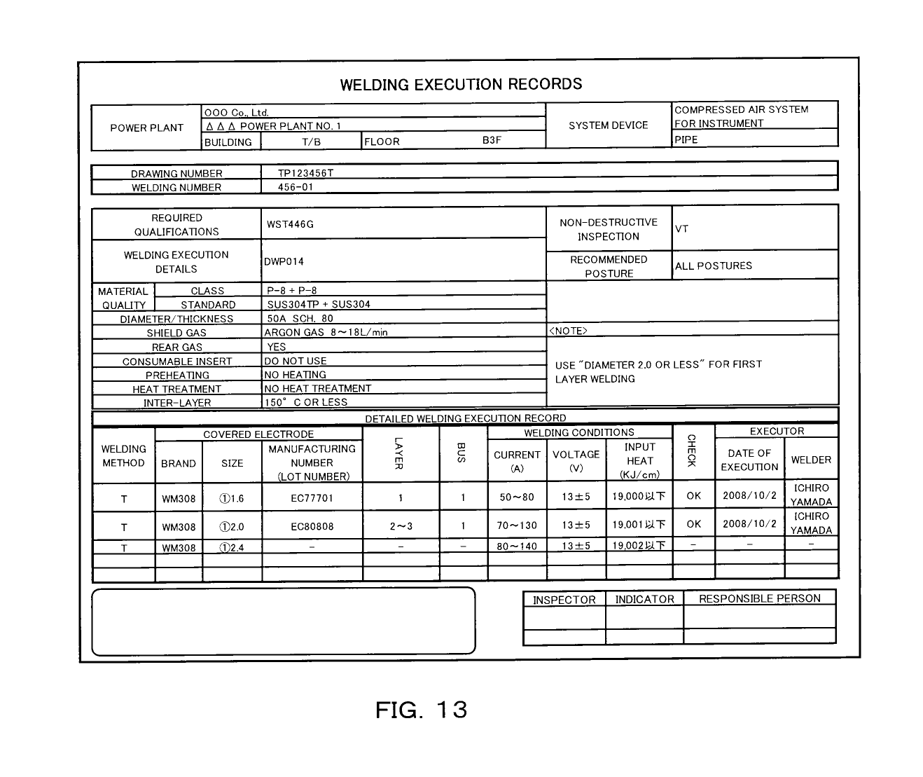

As shown in FIG. 23, the welding operation instruction unit 107 is a program that creates welding operation instruction information that associates weld materials identified by the weld material identification unit 105 and required welding qualifications identified by the welding qualification identification unit 106 for each weld joint based on welding joint specifications acquired from the weld joint specification table 101a using the welding joint identification number as a key. The welding operation instruction unit 107 also outputs welding operation instruction information to the welding execution information management unit 110 to cause the welding execution information management unit 110 to store the welding operation instruction information in the welding execution information table 101j as weld operation information containing no welding operation results. The welding operation instruction information is also output from the printer 30 as welding operation instructions in accordance with an output request from the user. Similarly, welding execution details are also output as detailed information of the welding execution. FIG. 12 is a diagram showing a concrete example of welding operation instructions.

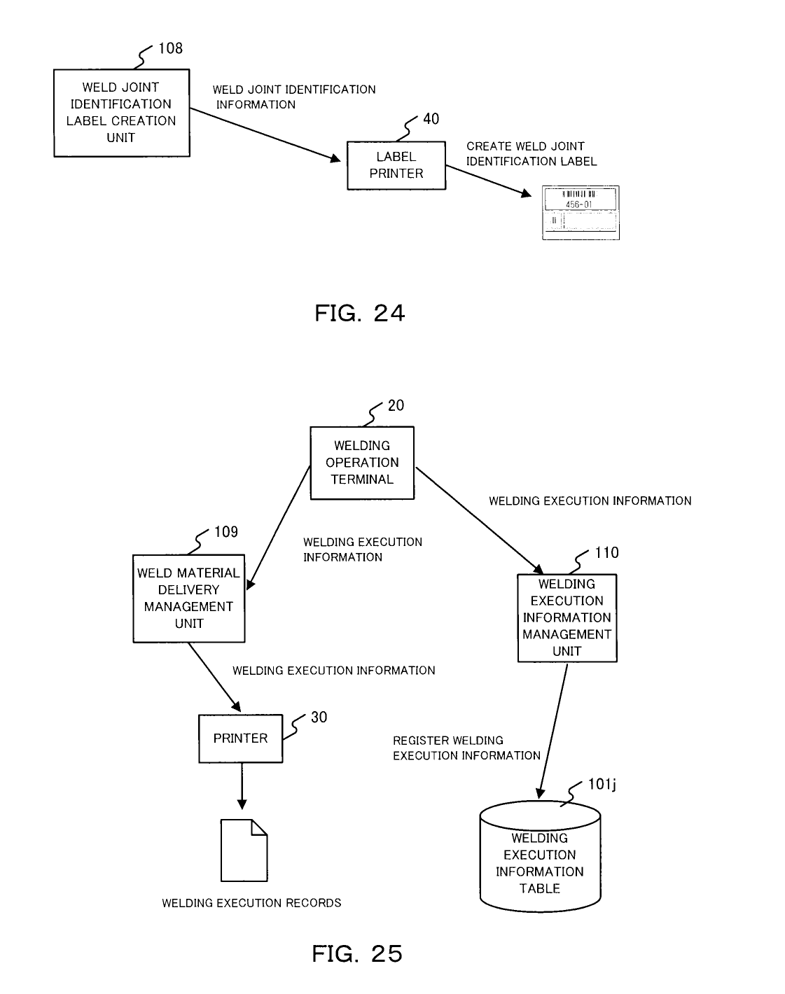

FIG. 24 is a correlation diagram of each program and the device for creation of a weld joint identification label. As shown in FIG. 24, the weld joint identification label creation unit 108 is a program that outputs weld joint identification information to the label printer 40 to cause the label printer 40 to create a weld joint identification label.

FIG. 25 is a correlation diagram of each program and the device for registration of welding execution information. As shown in FIG. 25, the weld material delivery management unit 109 is a program that creates weld material delivery slips to receive delivery of materials (such as the covered electrode/filler metal) necessary for welding operation from the weld material warehouse. Materials necessary for welding operations are listed in the screen of the welding operation terminal 20 based on welding operation instruction information captured by the welding operation terminal 20 and slips are automatically created after the welder inputs necessary quantities from the terminal.

As shown in FIG. 25, if the welding operation terminal 20 with which information of delivery slips drafted by the welder is registered is connected to a weld material warehouse administrator terminal (not illustrated) connected to the welding operation management device 10 in the weld material warehouse, the weld material delivery management unit 109 also displays the delivery information in the terminal. Then, if the weld material warehouse administrator inputs delivery quantities and manufacturing numbers of weld materials, the weld material delivery management unit 109 registers the delivery information with the weld material delivery information table 101i.

As shown in FIG. 25, the welding execution information management unit 110 is a program that acquires welding execution information input by the welder for the welding operation from the welding operation terminal 20 and also registers the welding execution information with the welding execution information table 101j. Registered welding execution information is output from the printer 30 as welding execution records in accordance with an output request from the user. FIG. 13 is a diagram showing a concrete example of welding execution records.

The data communication unit 111 is a program that receives data transmitted from the welding operation terminal 20 by wire or by radio by a communication device (not illustrated) and also transmits data and processing requests created by each unit of the welding operation management device 10 to the welding operation terminal 20.

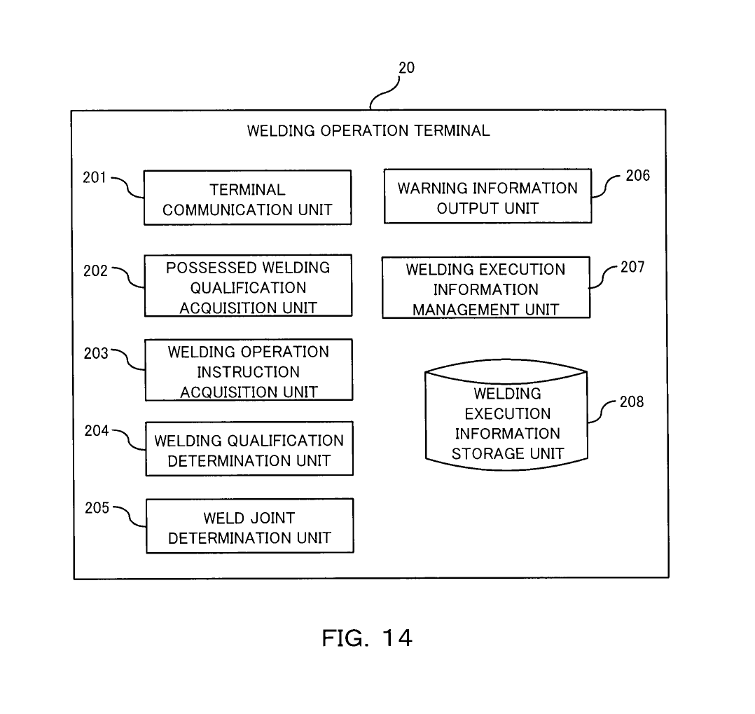

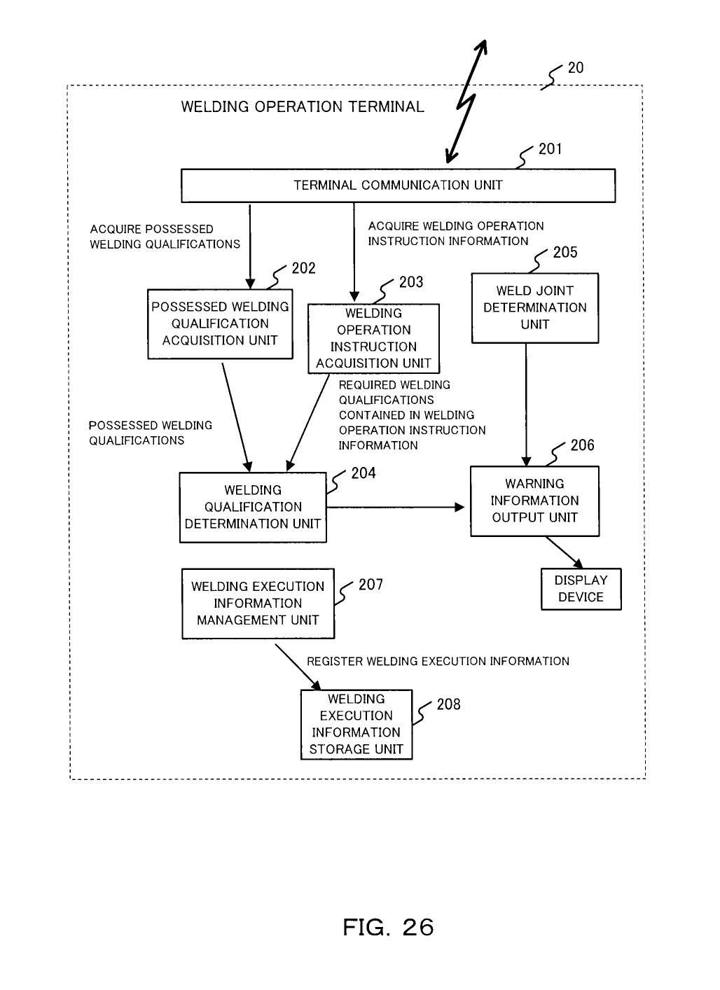

FIG. 14 is a block diagram showing a configuration example of the welding operation terminal 20. As shown in FIG. 14, the welding operation terminal 20 includes a terminal communication unit 201, a possessed welding qualification acquisition unit 202, a welding operation instruction acquisition unit 203, a welding qualification determination unit 204, a weld joint determination unit 205, a warning information output unit 206, a welding execution information management unit 207, and a welding execution information storage unit 208. FIG. 26 is a correlation diagram of each program of the welding operation terminal shown in FIG. 14.

The terminal communication unit 201 is a program that receives data transmitted from the welding operation management device 10 by wire or by radio by a communication device (not illustrated) and also transmits data and processing requests created by each unit of the welding operation terminal 20 to the welding operation management device 10.

The possessed welding qualification acquisition unit 202 is a program that acquires possessed welding qualifications of the welder via the terminal communication unit 201 by referring to the possessed welding qualification table 101h using the identification information of the welder as a key.

The welding operation instruction acquisition unit 203 is a program that acquires welding operation instruction information created by the welding operation management device 10 via the terminal communication unit 201. In the present embodiment, a welding operation instruction number marked as a barcode in welding operation instructions is read by a barcode reader (not illustrated) and the welding operation instruction number is used as a key to acquire welding operation instruction information from the welding operation management device 10.

The welding qualification determination unit 204 is a program that determines whether required welding qualifications contained in the welding operation instruction information acquired by the welding operation instruction acquisition unit 203 and possessed welding qualifications acquired by the possessed welding qualification acquisition unit 202 match for each weld joint.

The weld joint determination unit 205 is a program that determines, when the barcode of a weld joint identification label appended to a weld joint is read by the barcode reader (not illustrated), whether the weld joint is a weld joint instructed by welding operation specifications.

The warning information output unit 206 is a program that outputs warning information to a display device (not illustrated) included in the terminal based on determination results by the welding qualification determination unit 204 and the weld joint determination unit 205. The method of outputting warning information is not limited to the screen display and sound, light, vibration or the like may also be used.

The welding execution information management unit 207 is a program that creates weld procedure information by adding operation result information to the welding operation instruction information acquired by the welding operation instruction acquisition unit 203 and registers the weld procedure information with the welding execution information storage unit 208.

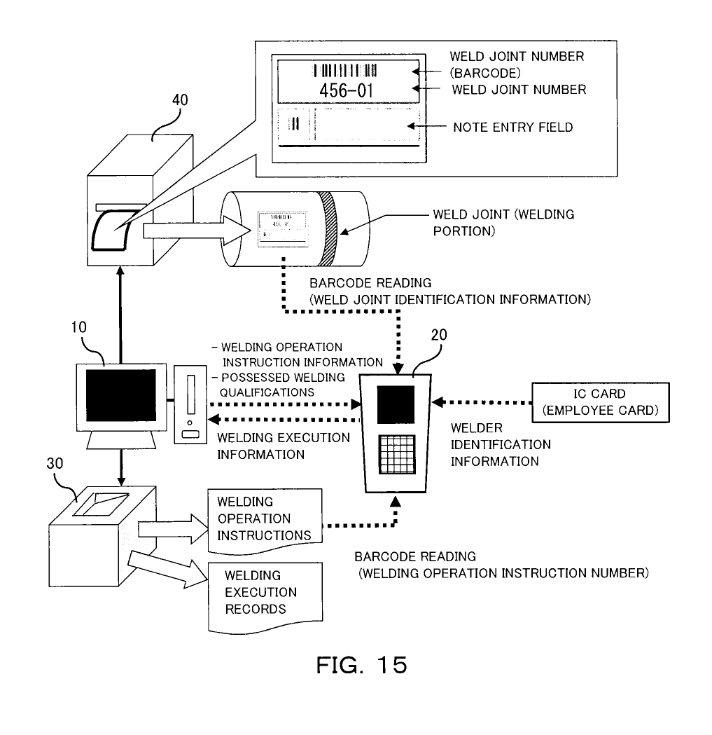

FIG. 15 is a correlation diagram illustrating an operation of a welding operation management system according to an embodiment of the present invention. First, when weld joint specifications are created by the welding operation management device 10, welding operation instructions are output from the printer 30.

Next, as shown in FIG. 24, when weld joint specifications are decided by the welding operation management device 10 (weld joint identification label creation unit 108), a welding joint identification label is output from the label printer 40 and the label is appended to the applicable pipe.

Next, as a preparation stage of the welding operation, when a welder uses an IC card reader (not illustrated) of the welding operation terminal 20 to read welder identification information from the IC card (such as an employee card) possessed by the welder, the welder identification information is used as a key to acquire possessed welding qualifications of the welder from the welding operation management device 10. When the barcode reader (not illustrated) of the welding operation terminal 20 is used to read a barcode marked in welding operation instructions, the welding operation instruction number represented by the barcode is used as a key to acquire welding operation instruction information from the welding operation management device 10.

As shown in FIG. 26, the welding operation terminal 20 compares acquired possessed welding qualifications and required welding qualifications of the welding operation instruction information to perform determination processing to determine whether the welder possesses required qualifications. Similarly, when the welder uses the barcode reader (not illustrated) of the welding operation terminal 20 to read the barcode marked on a weld joint identification label appended to a pipe, the welding operation terminal 20 compares weld joint identification information and the weld joint number of the welding operation instruction information to perform determination processing to determine whether the weld joint is intended for the welding operation. If execution conditions for a welding operation are determined to be satisfied in the determination processing, the welder performs the welding operation following the welding operation terminal 20 and creates a welding execution record.

Next, as shown in FIG. 25, the welding execution record is transmitted to the welding operation management device 10 (welding execution information management unit 110) before being stored in the database unit 101 (welding execution information table 101j). Then, if an output request of a welding execution record is made from the welding operation management device 10, welding operation instructions are output from the printer 30 to end a sequence of processes.

Processing of the weld joint specification inspection unit 103, the weld material identification unit 105, and the welding qualification identification unit 106 will be described in detail below.

### Inspection of Weld Joint Specifications

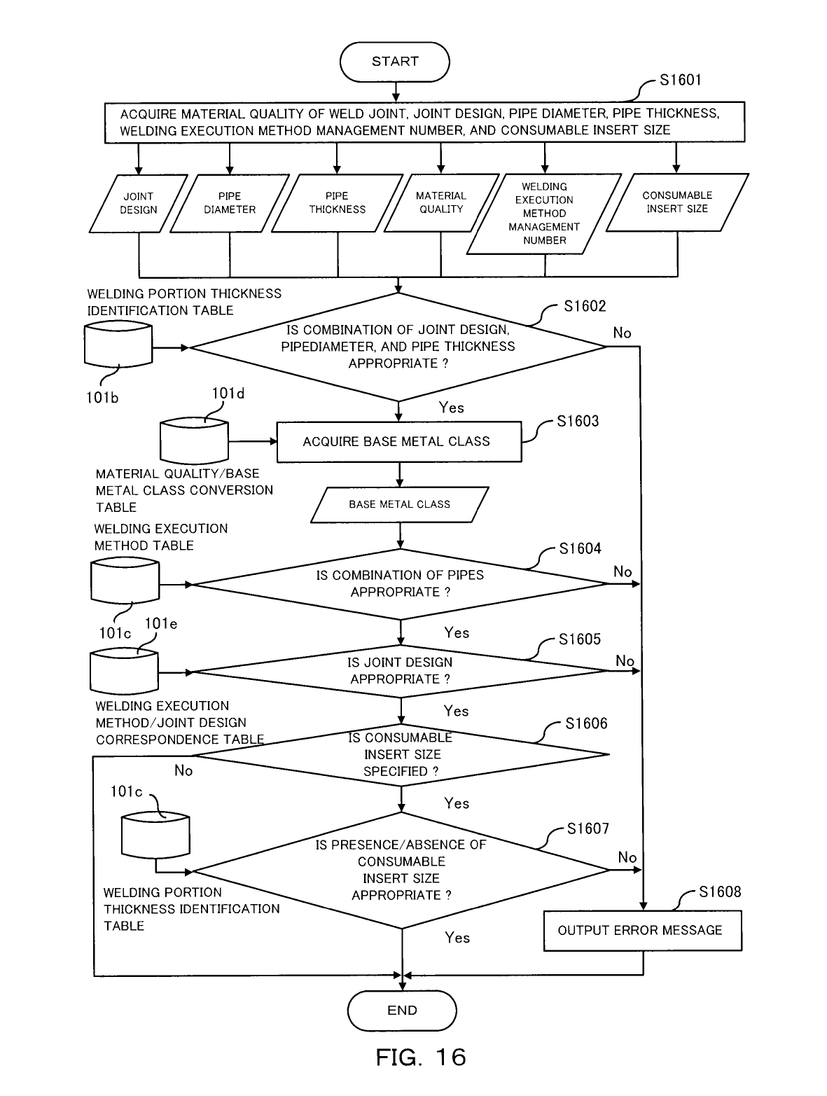

FIG. 16 is a flow chart showing a concrete example of processing of the weld joint specification inspection unit 103.

In S1601, as shown in FIG. 22, weld joint specifications (such as the material quality, joint design, pipe diameter, pipe thickness, welding execution method management number, and consumable insert size) input from the weld joint specification input unit 102 via the registration screen (not illustrated) are acquired. As weld joint specifications, for example, “welding number (weld joint number): 456-01, pipe diameter: 50A, pipe thickness: S80, welding execution method management number: DWP014, joint design: A, material quality of base metal (1): SUS304TP, material quality of base metal (2): SUS304TP” are acquired.

In S1602, the welding portion thickness identification table 101b is referred to based on the joint design, pipe diameter, and pipe thickness contained in the weld joint specifications to determine whether the combination thereof is appropriate. If the combination of the joint design, pipe diameter, and pipe thickness contained in the input weld joint specifications exists in the welding portion thickness identification table 101b and the combination is determined to be appropriate, the processing proceeds to S1603. By contract, if the combination thereof is determined to be inappropriate, the processing proceeds to S1608. If the welding portion thickness identification table 101b shown in FIG. 3 is referred to, for example, while the combination “joint design: A, pipe diameter: 50A, pipe thickness: S80” exists in the table and is determined to be appropriate, the combination “joint design: A, pipe diameter: 10A, pipe thickness: S40” does not exist in the table and is determined to be inappropriate.

In S1603, the material quality/base metal class conversion table 101d is referred to based on the material quality of the base metal (1) and base metal (2) contained in the weld joint specifications to acquire the base metal class. If the material quality/base metal class conversion table 101d shown in FIG. 5 is referred to, for example, when the material quality contained in the weld joint specifications is “SUS304TP”, “P-8” is acquired as the base metal class.

In S1604, the welding execution method table 101c is referred to based on the base metal class of the base metal (1) and base metal (2) to be welded and the welding execution method management number to determine whether the combination of pipe materials is appropriate. If the combination of pipe materials is determined to be appropriate, the processing proceeds to S1605. By contract, if the combination of the base metal (1) and base metal (2) is determined to be inappropriate, the processing proceeds to S1608. If the welding execution method table 101c shown in FIG. 4 is referred to, for example, when the base metal class of the base metal (1) and base metal (2) is “P-8” for both and the welding execution method number is “DWP014”, the data exists in the table and the combination is determined to be appropriate. When the base metal classes of the base metal (1) and base metal (2) are “P-1” and “P-5-1” and the welding execution method number is “DWP014”, the corresponding data does not exist in the table and the combination is determined to be inappropriate.

In S1605, the welding execution method/joint design correspondence table 101e is referred to based on the joint design and welding execution method management number contained in the weld joint specifications to determine whether the joint design is appropriate for the welding execution method. If the joint design is determined to be appropriate, the processing proceeds to S1606. By contrast, if the joint design is determined to be inappropriate, the processing proceeds to S1608. If the welding execution method/joint design correspondence table 101e shown in FIG. 6 is referred to, for example, when the welding execution method management number contained in the weld joint specifications is “DWP014”, if the joint design is “A”, the joint design is determined to be appropriate, and if the joint design is “Q”, the joint design is determined to be inappropriate.

In S1606, whether any consumable insert size in the weld joint specifications is specified is determined. If it is determined that a consumable insert size is specified, the processing proceeds to S1607. By contrast, if it is determined that no consumable insert size is specified, the processing is terminated.

In S1607, the welding execution method table 101c is referred to based on the welding execution method management number contained in the weld joint specifications to determine whether presence/absence of the consumable insert is appropriate for the welding execution method. If presence/absence of the consumable insert is determined to be appropriate, the processing is terminated. By contrast, if presence/absence of the consumable insert is determined to be inappropriate, the processing proceeds to S1608. If the welding execution method table 101c shown in FIG. 4 is referred to, for example, when the size of the consumable insert is specified in the weld joint specifications and when the welding execution method management number is “DWP014”, no use of the consumable insert is defined in the table and thus, the presence thereof is determined to be inappropriate.

In S1608, a relevant error message is output to the display device (not illustrated) to prompt for correction input before the processing being terminated.

### Identification of Weld Materials

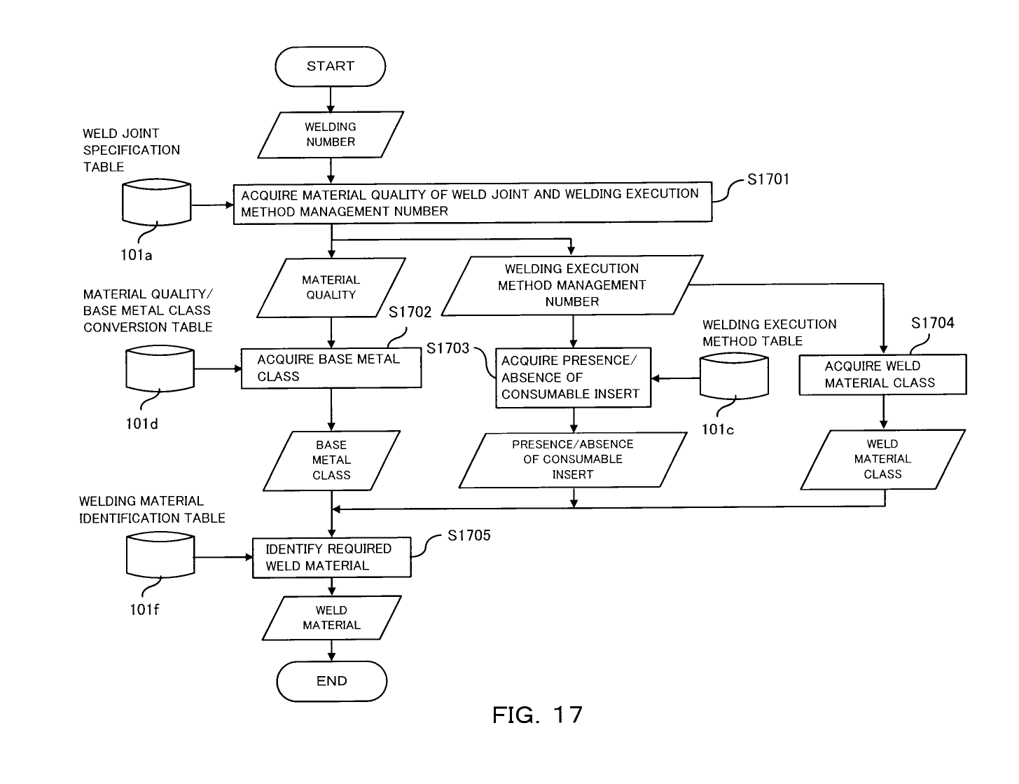

FIG. 17 is a flow chart showing a concrete example of processing of the weld material identification unit 105.

In S1701, as shown in FIG. 22, the weld joint specification table 101a is referred to by using the weld joint number as a key to acquire weld joint specifications (the material quality and welding execution method management number). If the weld joint specification table 101a shown in FIG. 2 is referred to, for example, “pipe diameter: 50A, pipe thickness: S80, welding execution method management number: DWP014, joint design: A, material quality of base metal (1): SUS304TP, material quality of base metal (2): SUS304TP” is acquired as weld joint specifications whose welding number (weld joint number) is “456-01”.

In S1702, the material quality/base metal class conversion table 101d is referred to based on the material quality of the base metal (1) and base metal (2) contained in the weld joint specifications to acquire the base metal class. If the material quality/base metal class conversion table 101d shown in FIG. 5 is referred to, for example, when the material quality contained in the weld joint specifications is “SUS304TP”, “P-8” is acquired as the base metal class.

In S1703, the welding execution method table 101c is referred to by using the welding execution method management number contained in the weld joint specifications as a key to acquire presence/absence of a consumable insert. If the welding execution method table 101c shown in FIG. 4 is referred to, for example, when the welding execution method management number is “DWP014”, information containing no consumable insert is obtained.

In S1704, the welding execution method table 101c is referred to by using the welding execution method management number contained in the weld joint specifications as a key to acquire the weld material class (covered electrode class and the filler metal class) for each of the base metal (1) and base metal (2). If the welding execution method table 101c shown in FIG. 4 is referred to, for example, when the welding execution method management number is “DWP014”, “covered electrode class: none, filler metal class: R-1” is acquired.

In S1705, the weld material identification table 101f is referred to based on the acquired base metal classes of the base metal (1) and base metal (2), presence/absence of the consumable insert, and weld material class to identify weld materials (such as weld material brands) before the processing being terminated. If the weld material identification table 101f shown in FIG. 7 is referred to, for example, when “weld material class: R-1, consumable insert: none, base metal class of the base metal (1) and base metal (2): P-8, material quality: SUS304”, “WM308” is identified as the weld material brand.

### Identification of Welding Qualifications

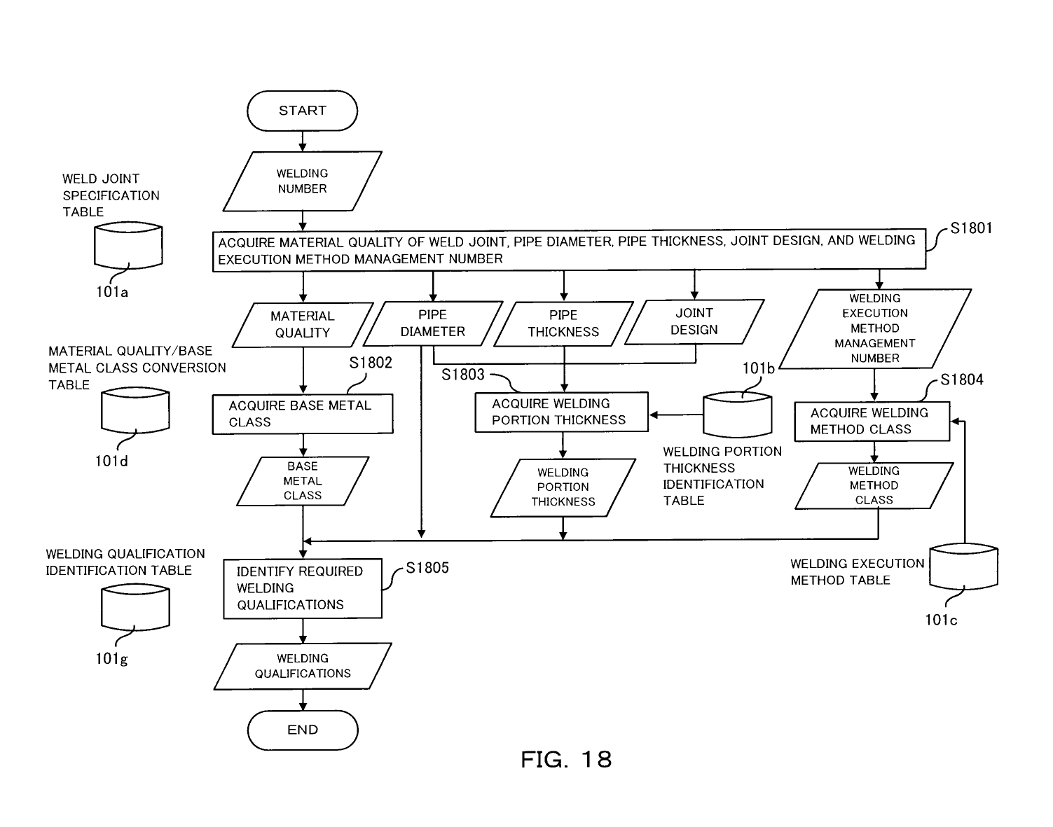

FIG. 18 is a flow chart showing a concrete example of processing of the welding qualification identification unit 106.

In S1801, as shown in FIG. 23, the weld joint specification table 101a is referred to by using the weld joint number as a key to acquire weld joint specifications (material quality, joint design, pipe diameter, pipe thickness, and welding execution method management number). The weld joint specification table 101a shown in FIG. 2 is referred to, for example, “pipe diameter: 50A, pipe thickness: S80, welding execution method management number: DWP014, joint design: A, material quality of base metal (1): SUS304TP, material quality of base metal (2): SUS304TP” is acquired as weld joint specifications whose welding number (weld joint number) is “456-01”.

In S1802, the material quality/base metal class conversion table 101d is referred to based on the material qualities of the base metal (1) and base metal (2) contained in the weld joint specifications to acquire the corresponding base metal classes. If the material quality/base metal class conversion table 101d shown in FIG. 5 is referred to, for example, when the material quality contained in the weld joint specifications is “SUS304TP”, “P-8” is acquired as the base metal class.

In S1803, the welding portion thickness identification table 101b is referred to based on the pipe diameter, pipe thickness, and joint design contained in the weld joint specifications to acquire the welding portion thickness. If the welding portion thickness identification table 101b shown in FIG. 3 is referred to, for example, when “pipe diameter: 50A, pipe thickness: S80, joint design: A”, the welding portion thickness is identified as 4.95 mm.

In S1804, the welding execution method table 101c is referred to by using the welding execution method management number contained in the weld joint specifications as a key to acquire the welding method class.

In S1805, the welding qualification identification table 101g based on the acquired base metal classes of the base metal (1) and base metal (2), welding portion thickness, and welding method class to identify welding qualifications required for the welding operation before the processing being terminated. If the welding qualification identification table 101g shown in FIG. 8 is referred to, for example, when “base metal class of the base metals (1) and (2): P-8, material quality of the base metals (1) and (2): SUS304TP, pipe diameter: 50A, welding method class: T”, “WST446G” is identified as required welding qualifications. Therefore, “WST446G” is recorded as required welding qualifications in welding operation instruction information. If the possessed welding qualification table 101h shown in FIG. 9 is referred to, it is clear that the welder “welder number: 080707, name: Ichiro Yamada” possesses required welding qualifications.

### Effects of the Present Embodiment

As described above, the following effects can be achieved by constructing a welding operation management system according to the present embodiment:

(1) Weld materials used for a welding operation and welding qualifications required for the welding operation can easily be identified.

(2) Mismatching of weld joint specifications can be prevented, improving design quality of weld joint specifications.

(3) Efficiency and reliability of welding operations and welding management work are improved. For example, the progress of each weld joint and usage of weld materials can be grasped correctly from a database group.

(4) Required welding qualifications derived from weld joint specifications and possessed welding qualifications of a welder are compared before a welding operation so that the welding operation can be performed by a suitable welder.

(5) In pipe inspection after the execution of work, an inspection list in accordance with the progress of inspection of each weld joint based on database storage content can be output so that erroneous inspection steps and skips of inspection items can be prevented. Moreover, there is no need to change content of the inspection list each time execution drawings are revised so that savings in labor can be achieved.

Incidentally, the present invention is not limited to the above embodiment as it is and can be embodied by modifying structural elements without deviating from the scope thereof in the stage of working. Moreover, various inventions can be formed by appropriately combining a plurality of structural elements disclosed by the above embodiment. For example, several structural elements may be deleted from all structural elements disclosed in the embodiment.

### Reference Signs List

10 Welding operation management device

20 Welding operation terminal

30 Printer

40 Label printer

101 Database unit

101a Weld joint specification table

101b Welding portion thickness identification table

101c Welding execution method table

101d Material quality/base metal class conversion table

101e Welding execution method/joint design correspondence table

101f Weld material identification table

101g Welding qualification identification table

101h Possessed welding qualification table

101i Weld material delivery information table

101j Welding execution information table

102 Weld joint specification input unit

103 Weld joint specification inspection unit

104 Weld joint specification registration unit

105 Weld material identification unit

106 Welding qualification identification unit

107 Welding operation instruction unit

108 Weld joint identification label creation unit

109 Weld material delivery management unit

110 Welding execution information management unit

111 Data communication unit

201 Terminal communication unit

202 Possessed welding qualification acquisition unit

203 Welding operation instruction acquisition unit

204 Welding qualification determination unit

205 Weld joint determination unit

206 Warning information output unit

207 Welding execution information management unit

208 Welding execution information storage unit

1. (canceled)

2. A welding operation management method, comprising:
a weld joint specification acquisition step of acquiring weld joint specifications from a weld joint specification table that stores a material quality of a pipe and a welding execution method by associating with a weld joint as the weld joint specifications between the pipes mutually welded in plant construction work using an identifier of the weld joint as a key;
a weld material class acquisition step of acquiring a weld material class from a welding execution method table that stores base metal classes classifying the material quality, the weld material classes classifying weld materials used for welding, and welding method classes classifying the welding execution methods by associating with the welding execution methods based on the welding execution method contained in the weld joint specifications acquired in the weld joint specification acquisition step; and
a weld material identification step of identifying the weld material concerning the weld joint from a weld material identification table that stores the base metal classes and the weld material classes by associating with identification information of the weld materials based on the base metal class concerning the material quality contained in the weld joint specifications and the weld material class acquired in the weld material class acquisition step.

3. A welding operation management method, comprising:
a weld joint specification acquisition step of acquiring weld joint specifications from a weld joint specification table that stores at least a material quality of an pipe, a joint design, a pipe diameter, a pipe thickness, and a welding execution method by associating with a weld joint as weld joint specifications between the pipes mutually welded in plant construction work using an identifier of the weld joint as a key;
a welding portion thickness acquisition step of acquiring a thickness of a welding portion from a welding portion thickness identification table that stores the joint design, the pipe diameter, and the pipe thickness by associating with the thickness of the welding portion based on the joint design, the pipe diameter, and the pipe thickness contained in the weld joint specifications acquired in the weld joint specification acquisition step;
a welding method class acquisition step of acquiring a weld material class from a welding execution method table that stores base metal classes classifying the material quality and welding method classes classifying the welding execution methods by associating with the welding execution methods based on the welding execution method contained in the weld joint specifications acquired in the weld joint specification acquisition step; and
a welding qualification identification step of identifying welding qualifications concerning the weld joint from a welding qualification identification table that stores the welding method classes, the base metal classes, and the pipe diameter by associating with the welding qualifications required for welding operations based on the base metal class concerning the material quality contained in the weld joint specifications, the thickness of the welding portion acquired in the welding portion thickness acquisition step, and the welding method class acquired in the welding method class acquisition step.

4. A welding operation management method, comprising:
a weld joint specification input step of inputting at least a material quality of an pipe, a joint design, a pipe diameter, a pipe thickness, and a welding execution method by associating with each weld joint as weld joint specifications between the pipes mutually welded in plant construction work via a registration screen displayed by a GUI;
a first consistency inspection step of inspecting consistency of the joint design, the pipe diameter, and the pipe thickness by referring to a welding portion thickness identification table that stores the joint design, the pipe diameter, and the pipe thickness by associating with a thickness of a welding portion using the joint design, the pipe diameter, and the pipe thickness input in the weld joint specification acquisition step as keys;
a second consistency inspection step of inspecting the consistency of a combination of the material qualities and the welding execution methods by referring to a welding execution method table that stores base metal classes classifying the material quality and welding method classes classifying the welding execution methods by associating with the welding execution methods using the material quality input in the weld joint specification input step as the key; and
a warning information output step of outputting warning information about the input weld joint specifications based on inspection results in the first and second consistency inspection steps.

5. A welding operation management method, comprising:
inputting at least an identifier of a weld joint, a welding execution method, a joint design, a material quality of a pipe, a pipe diameter, and a pipe thickness into a weld joint specification input unit as weld joint specifications between the pipes mutually welded in plant construction work;
storing the joint design, the pipe diameter, and the pipe thickness in a welding portion thickness identification table by associating with a thickness of a welding portion;
storing base metal classes classifying the material quality of the pipes, weld material classes classifying weld materials used for welding, and welding method classes classifying the welding execution methods in a welding execution method table by associating with the welding execution methods; and
inspecting consistency of the joint design, the pipe diameter, and the pipe thickness by referring to the welding portion thickness identification table using the joint design, the pipe diameter, and the pipe thickness having been input as keys and also inspecting the consistency of a combination of the material qualities of the pipes and the welding execution methods by referring to the welding execution method table using the base metal class concerning the material quality as the key.

6. The welding operation management method according to claim 5, further comprising:
registering the weld joint specifications with a weld joint specification table if an inspection of the joint design, the pipe diameter, and the pipe thickness made by referring to the welding portion thickness identification table has the consistency and further, the inspection of the combination of the material qualities of the pipes and the welding execution methods made by referring to the welding execution method table has the consistency.

7. The welding operation management method according to claim 6, further comprising: identifying the weld material by acquiring the welding execution method and the material quality of the pipe from the weld joint specification table and also acquiring the weld material class from the welding execution method table and registering the identified weld material with a weld material identification table that stores the base metal classes of the pipe, the material quality of the pipe, and the weld material classes by associating with brands of the weld materials.
